(19) United States
(12) Patent Application Publication
(10) Pub. No.: US 2013/0337666 A1
(43) Pub. Date: Dec. 19, 2013

(54) SUBSTRATE EMBEDDED ELECTRICAL INTERCONNECT

(71) Applicants: Joe F. Walczyk, Tigard, OR (US); Weida Qian, Hillsboro, OR (US)

(72) Inventors: Joe F. Walczyk, Tigard, OR (US); Weida Qian, Hillsboro, OR (US)

(21) Appl. No.: 13/976,441

(22) PCT Filed: May 29, 2012
(86) PCT No.: PCT/US12/39885

§ 371 Date: Jun. 26, 2013

(51) Int. Cl. H01R 12/71; H01R 43/20

(52) U.S. Cl. CPC H01R 12/712; H01R 43/205
USPC 439/66; 29/832

(57) ABSTRACT

Electronic assemblies and methods including the formation of interconnect assemblies are described. An electrical interconnection assembly may include a contact structure and a printed circuit board electrically coupled to the contact structure, the printed circuit board including an opening therein. The contact structure is positioned to extend within the opening in the printed circuit board and is movable in relation to the printed circuit board when a sufficient force is applied to the contact structure. Other embodiments are described and claimed.

### BACKGROUND

Interconnections in certain electronic device assemblies may be made using a socket through which electrical connections between a device and a printed circuit board (PCB) are made. The socket provides mechanical and electrical connection between the electronic device and the PCB. The electrical connection may be made without soldering the device to the PCB. Such sockets may be used in both final device configuration and during testing procedures to ensure proper electrical performance of a device or a portion thereof

### BRIEF DESCRIPTION OF THE DRAWINGS

Embodiments are described by way of example, with reference to the accompanying drawings, which are not necessarily drawn to scale.

FIG. 1 is a view of device electrically coupled to a PCB, in accordance with certain embodiments.

FIG. 2 is a view of an electrical connection from a device to a PCB, in accordance with certain embodiments.

FIG. 3 is a view of an interconnection from a device to a PCB using a tip positioned on a shaft that extends within a barrel embedded in the PCB, in accordance with certain embodiments. FIG. 4 is a view of a PCB including actuation mechanisms that may be controlled using pneumatics or hydraulics, in accordance with certain embodiments.

FIG. 5A is a view of a spring-loaded actuation mechanism extending through a PCB and into a structure positioned adjacent to the PCB, in accordance with certain embodiments.

FIG. 5B is a view of a spring-loaded actuation mechanism extending into a PCB, in accordance with certain embodiments.

FIGS. 6A-6D illustrate barrel structures in a PCB, in accordance with certain embodiments.

FIG. 7 illustrates a top view of a contact structure including a flanged configuration that extends over an end of a shaft in an interconnection structure, in accordance with certain embodiments.

FIG. 8 illustrates a top view of a contact structure including a bell-shaped configuration that extends over an end of a shaft in an interconnection structure, in accordance with certain embodiments.

FIG. 9 illustrates a flow chart of operations relating to forming an interconnection assembly, in accordance with certain embodiments.

FIG. 10 illustrates an electronic system arrangement in which embodiments may find application.

### DETAILED DESCRIPTION

In order to show features of various embodiments most clearly, the drawings included herein include representations of various electronic and/or mechanical devices. The actual appearance of the fabricated structures may appear different while still incorporating the claimed structures of the illustrated embodiments. Moreover, the drawings may show only the structures necessary to understand the illustrated embodiments. Additional structures known in the art have not been included to maintain the clarity of the drawings.

As noted above, a socket is often used in an assembly structure between a device and a PCB. However, higher device power and higher interface data rates lead to the need for shorter interconnect pathways (for lower inductance, lower signal loss, and lower interference). These issues are particularly evident, for example, during testing procedures, where high power and fast interface data rates are seen. In addition, as devices get thinner, problems such as warpage lead to the need to ensure adequate compliance in the Z-direction is needed to ensure reliable contact.

Certain embodiments provide for an electrical connection between a device and a substrate such as a PCB, in which a socket is not used. Such socket-less configuration permits a substantially shorter signal path, while also providing for adequate compliance in the Z-direction.

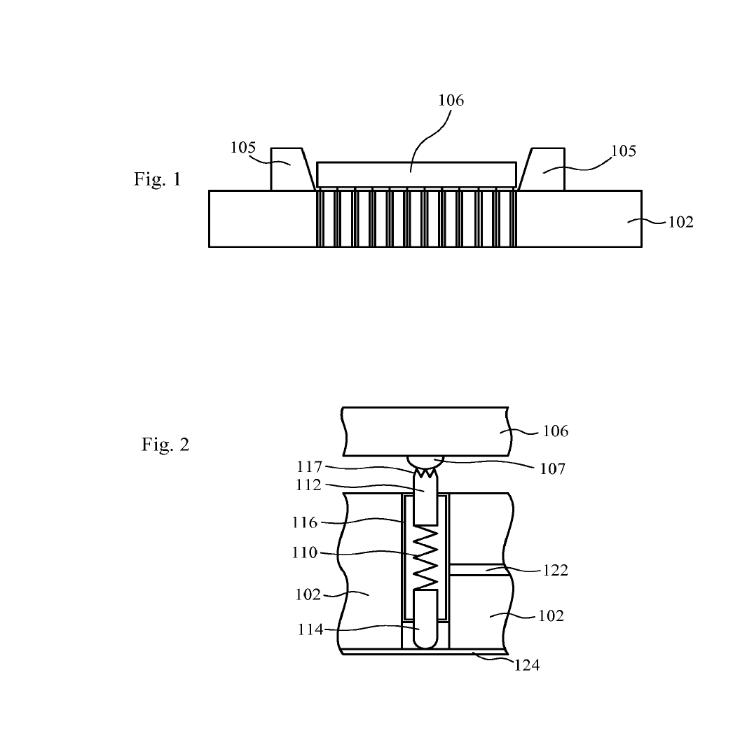

FIG. 1 illustrates a cross-sectional view of an assembly including a substrate such as a PCB 102 on which a device 106 is positioned. In certain embodiments, the device 106 is a device under test (DUT) and the PCB 102 is a test board. In other embodiments the device 106 may be any type of device, including, but not limited to, a CPU on a package substrate, that is electrically coupled to a PCB 102 that is a motherboard. An alignment structure such as alignment plate 105 may be positioned on the PCB 102 to ensure that the device 106 is properly positioned on the PCB 102 so that a suitable electrical connection may be made. The PCB 102 includes an opening extending therethrough. Within the opening is positioned a contact structure such as a contact pin 112 extending outward from the PCB 102 and making electrical contact with a contact pad 107 on the device 106. The contact pin 112 is in communication with spring 110, which is in turn in communication with pin 114 that engages a lower surface 124 positioned on the PCB 102. As illustrated in the cross-sectional view of FIG. 2, the contact pin 112 may include a tip 117 having a crown-like structure that contacts the pad 107 on the device 106. Other types of contact structures are also possible. The lower surface 124 acts as a backstop to enable to spring 110 to be actuated. Other configurations that act as a backstop to enable the spring 110 to be actuated may also be used. As illustrated in FIG. 2 the spring 110 is positioned between the contact pin 112 and the pin 114; however, the spring may also be wrapped around a portion of either or both of the pins 112, 114 or have some alternative connection mechanism to the pins 112, 114. In certain embodiments, one or both of the contact pin 112 and the pin 114 may be configured to engage the barrel 116 that is positioned within the opening in the PCB 102. The contact pin 112, the spring 110, and pin 114, and the barrel 110 may be formed from electrically conductive materials such as a metal, for example, Cu. The barrel 116 may be electrically coupled to the electrical trace 122 within the PCB 102.

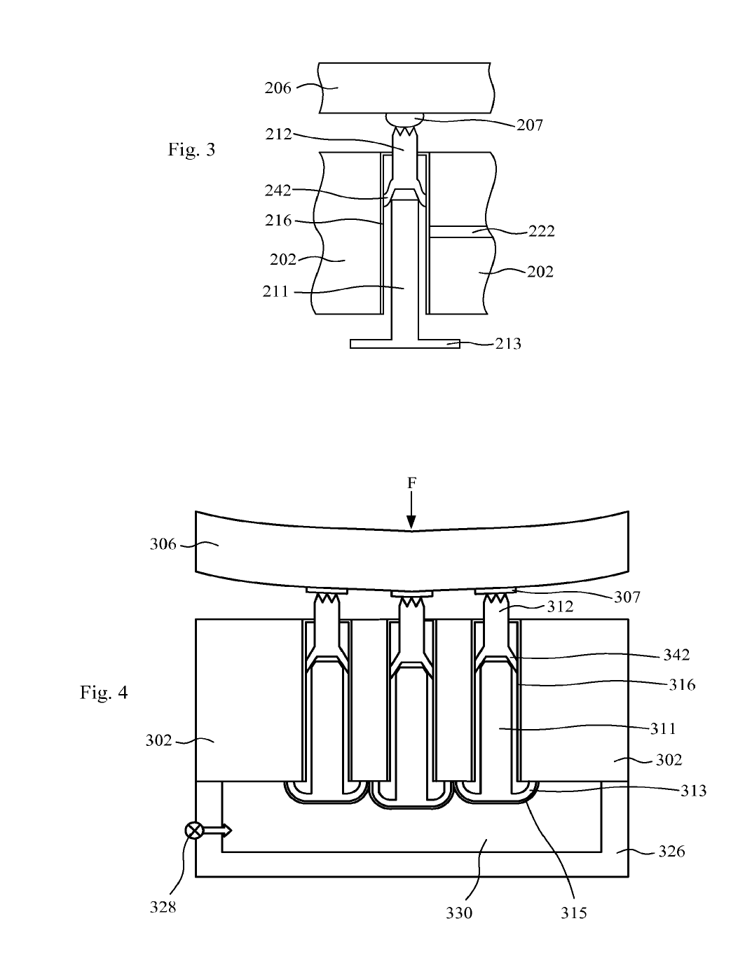

FIG. 3 illustrates a cross-sectional view of an assembly in accordance with certain embodiments, including an embedded pin structure having a different configuration from that illustrated in FIG. 2. In the configuration illustrated in FIG. 3, a contact pin 212 engages a rod 211. The rod 211 may move in the Z-direction (up and down in FIG. 3). The contact pin 212 is in communication with the rod 211 and can also move in the Z-direction. The rod 211, and in turn, the contact pin 212, may be configured to accept force from a variety of force actuation mechanisms including, but not limited to, a pneumatic mechanism, a hydraulic mechanism, and a spring. The configuration acts to mechanically decouple the contact pin 212 from the PCB 202 and enable the contact pin 212 to move relative to the PCB upon application of a sufficient force. The rod 211 may be configured to include a flange region 213 to provide a region to accept an applied force. The electrical pathway between the device 206 and the PCB 202 may pass through the contact pin 212 to the barrel 216 and then to the electrical trace 222 in the PCB. The contact pin 212 includes a flared-out region 242 that is in electrical contact with and slides or brushes against the barrel 216.

FIG. 4 illustrates a cross-sectional view of an assembly in accordance with certain embodiments, including a body that houses at least a portion of the force actuation mechanism. An example of such a body is the manifold 326 coupled to a PCB 302. The manifold 326 may be configured to define a chamber 330 to house a fluid therein. The term fluid as used herein includes liquids and gases. The assembly also includes a plurality of embedded interconnect structures for making electrical contact to a device. While FIG. 4 illustrates three interconnect structures, any desired number of interconnect structures may be used. The interconnect structures include a contact pin 312, rod 311 having flange portion 313, and barrel 316. The force actuation mechanism illustrated in FIG. 4 may provide a pneumatic or hydraulic force applied through the rod 311 to the contact pin 312. The rod 311 and contact pin 312 may move in the Z-direction (up and down in FIG. 4) within the barrel 316. The contact pin 312 includes flared-out region 342 that is in slidable contact with the barrel 316. The manifold 326 includes a fluid intake 328 for controlling the fluid inside the chamber 330 in the manifold 326. The fluid in the manifold 326 applies a force to the rods 311 through the flange portion 313. The flange portion 313 may be shaped in any desired geometry to transmit force along the rod 311. The flange portion 313 may be formed from a flexible material that can move in response to forces applied thereto. In certain embodiments, the rod 311 is formed from an electrically insulating material such as, for example, a polymer. A membrane seal 315 may be positioned to separate the flange portion 313 of each of the rods 311 from the fluid in the chamber 330 in the manifold 326. The pressure of the fluid in the chamber 330 may be controlled so that a contact force is applied to place the contact pins 312 into proper contact with a device, while at the same time providing for compliance in the assembly. The embodiment illustrated in FIG. 4 includes the device 306 being positioned on the PCB 302 through the contact pins 312, with no other structure positioned therebetween.

The presence of the force actuation mechanism enables the assembly to have compliance to ensure a good electrical connection is made, even if one or both of the device and substrate do not have a uniform surface (for example, warped). In the configuration illustrated in FIG. 4, for example, a device 306 includes a lower surface that is not flat. Upon application of a downward force F to the device 306, the presence of the force actuation mechanism permits the contact pin 312 of the middle interconnect structure to move to a lower vertical position than the contact pins 312 of the two outer interconnect structures in order to accommodate the lower vertical position of the middle interconnect structure bonding pad 307 on the device 306. In addition to providing compliance to accommodate a varying topography, the force actuation mechanism also provides a suitable force to reach the contact pin so that the contact pin 312 can break through impurities or oxide on the surface of the pad 307 on the device 306 to ensure a good electrical connection. If the force on the contact pin 312 is too great, however, the pin 312 or the device 306 may be damaged. The force required to obtain a good electrical connection is dependent on a number of variables, including, but not limited to, the material(s) used for the pad 307 and the contact structure 312, the topology of the device 306 and the PCB 302, and the presence of impurities or oxides on the pad 307 or contact structure 312. The use of the force actuation mechanism permits the assembly to have compliance and to provide a suitable application of force to establish a good electrical connection even for non-uniform surfaces. The use of a hydraulic or pneumatic force actuation mechanism enables a uniform actuation force to be applied to the contact structure.

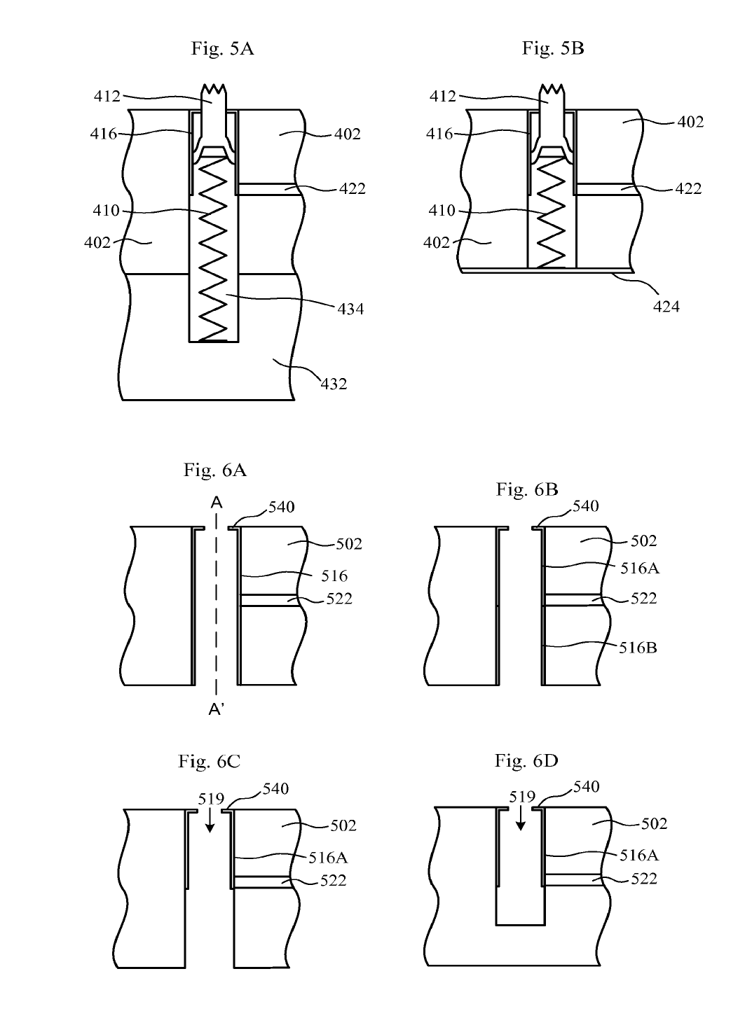

FIG. 5A illustrates a cross-sectional view of an assembly in accordance with certain embodiments, including an embedded interconnect structure in a PCB 402. The assembly includes a spring 410 adapted to contact a contact pin 412 that extends out from the PCB 402 to contact a device (not shown in FIG. 5A). The spring 410 extends beyond a lower surface of the PCB 402 as illustrated in FIG. 5A and into another structure 432 coupled to the lower surface of the PCB 402. The structure 432 includes an opening 434 into which a portion of the spring 410 extends. The structure 432 may be formed from a variety of materials, including, but not limited to, polymers.

FIG. 5B illustrates an assembly similar to that of FIG. 5A, with the use of a shorter spring that rests against a layer 424 positioned at the lower surface of the PCB 402. In this embodiment the spring does not extend into a structure beyond the PCB 402, but uses the layer 424 as a support. The configuration of FIG. 5A permits the use of a longer spring, if desired. Embodiments as illustrated in FIGS. 5A and 5B permit a short electrical path extending, for example, from the contact pin 412 to the barrel 416 to the trace 422. In such embodiments, the spring 410 need not be part of the electrical path and need not be formed from an electrically conductive material. Also, the barrel 416 need not extend below the level of the trace 422.

Embodiments may include a barrel structure that is positioned in an opening formed in the PCB. In certain embodiments, the barrel may be used as part of the electrical path for signals to travel between the PCB and the device, and as a result, may be formed from an electrically conductive material including, but not limited to, a metal such as copper. In certain embodiments, the barrel may extend through the entire thickness of the PCB, whereas in other embodiments the barrel may extend only through a portion of the PCB. FIGS. 6A-6D illustrate cross-sectional views of barrel structures in a PCB, with FIG. 6A illustrating a barrel 516 extending through PCB 502. A contact structure such as the contact pin 412 of FIGS. 5A-B may be positioned to extend within the barrel 516 along the longitudinal axis A-A′ defined by the opening in the PCB 502. As illustrated in FIGS. 6A-6D, an upper end of the barrel 516 may include a flange region 540 that extends inward towards the axis A-A′ of the barrel 516. The flange region 540 may in certain embodiments slidably engage a contact structure positioned within the barrel 516.

FIG. 6B illustrates an embodiment including a barrel structure having a first portion 516A and a second portion 516B. As illustrated in FIG. 6B, first portion 516A is positioned within an upper part of the PCB 502, and second portion 516B is positioned within a lower part of the PCB 502. In certain configurations, the PCB 502 includes electrical traces within the thickness of the PCB, such as electrical trace 522. As noted above, in certain embodiments the barrel may be used as part of the electrical interconnection. As a result, as illustrated in FIG. 6B, the barrel 516A may be in electrical contact with trace 522. In such an embodiment, the barrel 516A is formed from an electrically conductive material. The barrel portion 516B is not needed for the electrical connection to the trace 522 and as a result, the barrel portion 516B may be formed from a material that is not electrically conductive such as an oxide or a polymer. In alternative embodiments, the barrel may extend to any length needed to make an electrical connection with a feature in or on the PCB. For example, FIG. 6C illustrates an embodiment in which the barrel includes only portion 516A, and does not extend through the entire length of the opening 519 extending through the PCB 502. FIG. 6D is similar to FIG. 6C but illustrates the opening 519 extending through only a portion of the PCB 502 instead of entirely therethrough. Such an embodiment may be used, for example, with a short spring as a force actuation mechanism.

As described above, the contact pin may in certain embodiments make electrical contact with the barrel within the PCB. As illustrated in the cross-sectional view of FIG. 3, for example, the contact pin 212 is in electrical contact with the barrel 216. As seen in FIG. 3, for example, a bottom portion of the contact pin 212 includes a flared-out region 242. An end surface of the flared-out region contacts the barrel 216. Another way to describe the flared-out region 242 is that it is bell-shaped. The bell-shaped configuration permits an upper portion of the rod 211 to be tightly sealed within the opening in the bell-shaped region, which in turn acts to apply an outward force to press the bell-shaped or flared out region 242 against the barrel 216. The flared-out region 242 of the contact pin may have a variety of shapes in addition to that illustrated in FIG. 3. For example, the flared-out region 242 in FIG. 3 had top and bottom surface that are somewhat curved, whereas the flared-out region 343 in FIG. 4 has top and bottom surface that are straight.

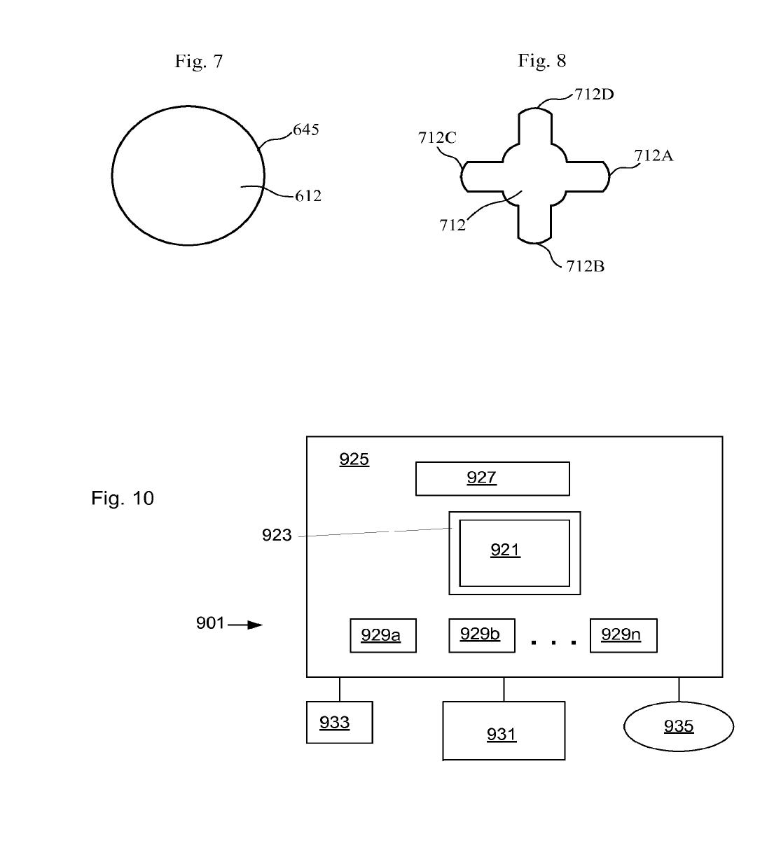

FIG. 7 shows a top down view showing a flared-out or bell-shaped structure of a contact pin 612 from above, with a region extending along the perimeter 645 positioned to be in contact with and slide against the interior surface of a barrel (not shown in FIG. 7), in accordance with certain embodiments. The bell-shaped structure of FIG. 7 is somewhat rigid, and in certain embodiments a more flexible design may be used.

FIG. 8 illustrates a top down view of a contact pin structure 712 that includes a plurality of flanges 712A, 712B, 712C, and 712D that extend outward to contact and slide against a barrel (not shown in FIG. 8). The structure of FIG. 8 is similar to that of FIG. 7, with portions of the bell-shaped structure being removed so that the flanges 712A-712D remain, Such flanges 712A-712D will be more flexible than the bell-shaped structure of FIG. 7.

Certain embodiments also relate to methods for forming assemblies including interconnections between a PCB and a device. Such assemblies include assemblies for use in products and also include removable interconnection assemblies, such as, for example, test assemblies where the contact between a PCB and a device is temporary. Other assemblies may include devices coupled to a PCB such as a motherboard. Still other assemblies may include devices coupled to a more compact PCB such as, for example, a daughter board or other board for coupling one or more devices thereto.

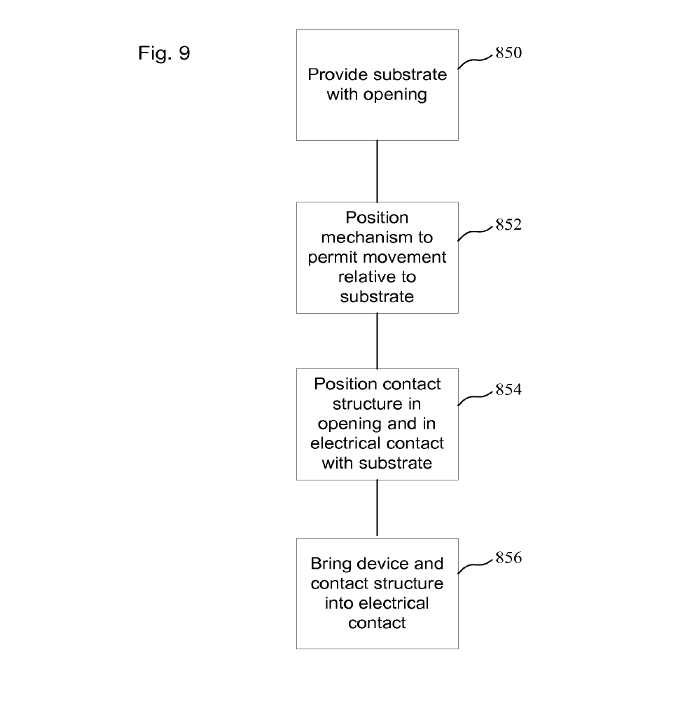

FIG. 9 illustrates a flowchart of operations relating to forming an interconnection assembly, in accordance with certain embodiments. Box 850 is providing a substrate including an opening therein. In certain embodiments the opening may extend all the way through the substrate and in other embodiments the opening may extend only partially through the substrate. The substrate may in certain embodiments take the form of a printed circuit board. Box 852 is positioning a mechanism to permit movement relative to the substrate. As described above, the mechanism may in certain embodiments be a force actuation mechanism such as a spring that extends entirely or partially within the opening and on which a contact structure is coupled. The spring provides compliance in the Z direction and enables the contact structure to move relative to the substrate in response to forces from a device positioned thereon. Other mechanisms such as, for example, hydraulic or pneumatic, may also be used. Box 854 is positioning the contact structure, such as a pin, in the opening and in electrical contact with an electrically conductive portion of the substrate such as a wiring trace therein. In certain embodiments, depending on the exact configuration of the force actuation mechanism and the contact structure, the contact structure may be positioned prior to, at the same time as, or after the force actuation mechanism. The contact structure may be integral with the force actuation mechanism in certain embodiments. Box 856 is electrically coupling a device, such as a semiconductor device, with the contact structure so that the device is electrically coupled to the substrate. This may be accomplished in certain embodiments by applying a force such as a downward force onto the device, which in turn presses on the contact structure, which is in turn coupled to a force actuation device such as, for example, a spring, that can provide a counter force to ensure a suitable electrical contact is made between the contact structure and the device. The use of the force actuation device permits the assembly to have compliance to ensure a smooth application of a suitable amount of force. It should be appreciated that various modifications may be made to the operations described in the flowchart.

Certain embodiments provide a number of advantages including shorter signal path from a device such as a semiconductor integrated circuit device to a substrate such as a printed circuit board due in part to the elimination of the socket. In addition, the force actuation mechanism (including, but not limited to a spring mechanism, a pneumatic mechanism or a hydraulic mechanism) to provide a contact force enables careful control of such forces to ensure that adequate electrical contact is made, even for warped devices. Furthermore, certain embodiments utilize separate elements for the electrical path (for example, the contact pin and the barrel) and for the mechanical compliance (for example, the spring or rod that delivers force to the contact pin). This permits a short electrical interconnect length while also permitting a longer length for the mechanical compliance to take place. A socket-less configuration also lowers the physical height of the assembly, which is of great importance in certain applications where smaller physical dimensions are particularly important, for example, mobile products.

Assemblies including structures formed as described in embodiments above may find application in a variety of electronic components. FIG. 10 schematically illustrates one example of an electronic system environment in which aspects of described embodiments may be embodied. Other embodiments need not include all of the features specified in FIG. 10, and may include alternative features not specified in FIG. 10.

The system 901 of FIG. 10 may include at least one central processing unit (CPU) 921. The CPU 921, also referred to as a microprocessor, may be a die attached to a package substrate 923, which is then coupled to a PCB 925 (for example, a motherboard). The package substrate 923 coupled to the PCB 925 is an example of an assembly that may be formed in accordance with embodiments such as described above. A variety of other system components, including, but not limited to memory and other components discussed below, may also include assemblies formed in accordance with embodiments such as described above.

The system 901 may further include memory 927 and one or more controllers 929a, 929b . . . 929n, which are also disposed on the PCB 925. The PCB 925 may be a single layer or multi-layered board which has a plurality of conductive lines that provide communication between the circuits in the CPU 921 in the package 923 and other components mounted to the PCB 925. Alternatively, one or more of the CPU 921, memory 927 and controllers 929a, 929b . . . 929n may be disposed on other cards such as daughter cards or expansion cards. In various embodiments, any combination of the CPU 921 (and package 923), memory 927 and controllers 929a, 929b . . . 929n may be formed in accordance with embodiments as described here and be directly coupled to the PCB, or one or more of the components may be coupled to the PCB using other configurations, such as being seated in sockets. Alternatively, a number of the components may be integrated into the same package and then coupled to a PCB. A display 931 may also be included.

Any suitable operating system and various applications execute on the CPU 921 and reside in the memory 927. The content residing in memory 927 may be cached in accordance with known caching techniques. Programs and data in memory 927 may be swapped into storage 933 as part of memory management operations. The system 901 may comprise any suitable computing device, including, but not limited to, a mainframe, server, personal computer, smart phone, workstation, laptop, handheld computer, netbook, tablet, book reader, handheld gaming device, handheld entertainment device (for example, MP3 (moving picture experts group layer—3 audio) player), PDA (personal digital assistant) telephony device (wireless or wired), network appliance, virtualization device, storage controller, network controller, router, etc.

The controllers 929a, 929b . . . 929n may include one or more of a system controller, peripheral controller, memory controller, hub controller, I/O (input/output) bus controller, video controller, network controller, storage controller, communications controller, etc. For example, a storage controller can control the reading of data from and the writing of data to the storage 933 in accordance with a storage protocol layer. The storage protocol of the layer may be any of a number of known storage protocols. Data being written to or read from the storage 933 may be cached in accordance with known caching techniques. A network controller can include one or more protocol layers to send and receive network packets to and from remote devices over a network 935. The network 935 may comprise a Local Area Network (LAN), the Internet, a Wide Area Network (WAN), Storage Area Network (SAN), etc. Embodiments may be configured to transmit and receive data over a wireless network or connection. In certain embodiments, the network controller and various protocol layers may employ the Ethernet protocol over unshielded twisted pair cable, token ring protocol, Fibre Channel protocol, etc., or any other suitable network communication protocol.

Terms such as “first”, “second”, and the like may be used herein and do not necessarily denote any particular order, quantity, or importance, but are used to distinguish one element from another. Terms such as “top”, “bottom”, “upper”, “lower”, “upward”, “downward”, “overlying”, and the like may be used for descriptive purposes only and are not to be construed as limiting. Embodiments may be manufactured, used, and contained in a variety of positions and orientations.

In the foregoing Detailed Description, various features are grouped together for the purpose of streamlining the disclosure. This method of disclosure is not to be interpreted as reflecting an intention that the claimed embodiments of the invention require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

While certain exemplary embodiments have been described above and shown in the accompanying drawings, it is to be understood that such embodiments are merely illustrative and not restrictive, and that embodiments are not restricted to the specific constructions and arrangements shown and described since modifications may occur to those having ordinary skill in the art.

What is claimed:

1. An electrical interconnection assembly comprising:
a contact structure;
a printed circuit board electrically coupled to the contact structure, the printed circuit board including an opening therein;
the contact structure being positioned to extend within the opening in the printed circuit board, the contact structure being movable in relation to the printed circuit board when a sufficient force is applied to the contact structure.

2. The assembly of claim 1, further comprising a barrel positioned in the opening, wherein the contact structure is electrically coupled to the barrel, and the barrel is electrically coupled to the printed circuit board.

3. The assembly of claim 1, further comprising a spring positioned in the opening, the contact structure being positioned in communication with the spring.

4. The assembly of claim 1, wherein the opening extends partially through the printed circuit board.

5. The assembly of claim 1, wherein the opening extends entirely through the printed circuit board.

6. The assembly of claim 1, the assembly further comprising a force actuation mechanism positioned in communication with the contact structure.

7. The assembly of claim 6, wherein the force actuation mechanism includes a mechanism selected from the group selected of a hydraulic mechanism, a pneumatic mechanism, and a spring.

8. The assembly of claim 7, wherein the opening extends from a first surface of the printed circuit board to a second surface of the printed circuit board, and wherein the contact structure extends to a position outside of the opening on the first surface of the printed circuit board, the assembly further comprising a body positioned on the second surface of the printed circuit board, the body housing at least a portion of the force actuation mechanism.

9. The assembly of claim 6, wherein the force actuation mechanism comprises a spring.

10. The assembly of claim 6, wherein the force actuation mechanism comprises a hydraulic mechanism.

11. The assembly of claim 6, wherein the force actuation mechanism comprises a pneumatic mechanism.

12. The assembly of claim 9, wherein the spring in entirely positioned within the printed circuit board.

13. The assembly of claim 1, further comprising a semiconductor device electrically coupled to the contact structure.

14. The assembly of claim 6, the contact structure comprising a pin, wherein the pin includes a first end adapted to be electrically coupled to a semiconductor device, and a second end adapted to be in communication with the force actuation mechanism.

15. An electrical interconnection assembly comprising:
a printed circuit board having an opening therein, the opening defining a longitudinal axis;
a contact structure positioned in the opening in the printed circuit board;
the contact structure extending to a position outside of the opening;
the contact structure comprising an electrically conductive material;
the contact structure positioned in the opening in the printed circuit board so that the contact structure can move in a direction parallel to the longitudinal axis of the opening upon application of a sufficient force to the contact structure; and
the contact structure being electrically coupled to the printed circuit board.

16. The assembly of claim 14, further comprising a barrel positioned in the opening, wherein the contact structure is in electrical contact with the barrel, and the barrel is in electrical contact with the printed circuit board.

17. The assembly of claim 16, the assembly further comprising a force actuation mechanism positioned in communication with the contact structure, the force actuation mechanism selected from the group selected of a hydraulic mechanism, a pneumatic mechanism, and a spring.

18. The assembly of claim 15, wherein the opening extends from a first surface of the printed circuit board to a second surface of the printed circuit board, and wherein the contact structure extends to a position outside of the opening on the first surface of the printed circuit board, the assembly further comprising a body positioned on the second surface of the printed circuit board, the body housing at least a portion of the force actuation mechanism.

19. The assembly of claim 15, further comprising a semiconductor device electrically coupled to the contact structure.

20. A method for electrically coupling a semiconductor device to a printed circuit board in the absence of a socket therebetween, comprising:
positioning a contact structure in an opening in a printed circuit board, the opening defining a longitudinal axis;
the contact structure configured to be movable along the longitudinal axis within the opening;
the contact structure positioned to be electrically coupled to the printed circuit board.

21. The method of claim 20, further comprising positioning a barrel in the opening, the barrel being electrically coupled to the contact structure and to the printed circuit board.

22. The method of claim 20, further comprising positioned the contact structure into communication with a force actuation mechanism.

23. The method of claim 20, wherein the positioning the contact structure into communication with the force actuation mechanism comprises placing the contact structure into communication with a force actuation mechanism selected from the group consisting of a spring, a hydraulic mechanism, and a pneumatic mechanism.
